(19) United States
(12) Patent Application Publication
(10) Pub. No.: US 2010/0185501 A1
(43) Pub. Date: Jul. 22, 2010

(54) Mobile Advertising Device and Application Thereof

(75) Inventors: Li-Der Chou, Jhongli City (TW); Wei-Sheng Chen, Kaohsiung City (TW); Yao-Tsung Yang, Taoyuan City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: National Central University, Jhongli City (TW)

(21) Appl. No.: 12/472,671

(22) Filed: May 27, 2009

(30) Foreign Application Priority Data
Jan. 16, 2009 (TW) 98101683

(51) Int. Cl. G06Q 30/00; G01C 21/00; G09G 5/00

(52) U.S. Cl. 705/14.4; 701/300; 345/204

(57) ABSTRACT

A mobile advertising device includes an e-paper, a display control unit, a wireless communication unit and a processing unit. The display control unit controls the e-paper. The positioning unit receives a positioning signal and calculates the present location of the mobile advertising device according to the positioning signal. The wireless communication unit builds a connection with a server through wireless communication and transmits the present location of the mobile advertising device to the server. The processing unit includes an advertising module to obtain at least one advertisement of at least one store corresponding to the present location of the mobile advertising device from the server through the wireless communication unit. Then, the advertising module displays the advertisement of the store on the e-paper through the display control unit.

### RELATED APPLICATIONS

This application claims priority to Taiwan Application Serial Number 98101683, filed Jan. 16, 2009, which is herein incorporated by reference.

### BACKGROUND

1. Field of Invention

The present invention relates to a display device and application thereof. More particularly, the present invention relates to an advertisement display device and application thereof.

2. Description of Related Art

In our daily life, there are many different mobile advertisement media, such as light boxes, taxis and buses. When using the above-mentioned media displays for advertisements, the content of the advertisement can't be changed as the media moves to different places. In addition, the content of the advertisement displayed on the above-mentioned media can't be changed in real-time either. Therefore, it's impossible for the above-mentioned media to display real-time advertisements, such as advertisements for limited shopping activities.

Real-time advertisement media, such as TV walls, is huge and can only be installed in a fixed place. Therefore, the real-time advertisement media can't be easily moved to different places according to different needs of different advertisements. In addition, when the real-time advertisement media brings few advertising effects, the only way to improve their advertising effect may be uninstalling the real-time advertisement media and reinstalling them at other places, which costs a lot of money.

### SUMMARY

According to one embodiment of this invention, a mobile advertising device is provided. The mobile advertising device includes an e-paper, a display control unit, a positioning unit, a wireless communication unit and a processing unit. The display control unit controls the e-paper. The positioning unit receives a positioning signal and calculates the present location of the mobile advertising device according to the positioning signal. The wireless communication unit builds a connection with a server through wireless communication and transmits the present location of the mobile advertising device to the server. The processing unit includes an advertising module to obtain at least one advertisement of at least one store corresponding to the present location of the mobile advertising device from the server through the wireless communication unit. Then, the advertising module displays the advertisement of the store on the e-paper through the display control unit.

According to another embodiment of this invention, a mobile advertising system is provided. Wherein a server of the mobile advertising system selects at least one advertisement of at least one store corresponding to the present location of the mobile advertising device of the mobile advertising system and makes the advertisement of the store displayed on an e-paper of the mobile advertising device. The server includes a storage unit, a wireless communication unit and a processing unit. The storage unit stores advertisement information, wherein location information corresponding to the advertisement information is attached in the advertisement information. The wireless communication unit builds a connection with the mobile advertising device through wireless communication, and receives the present location of the mobile advertising device. The processing unit includes an advertisement-processing module to select the advertisement of the store from the advertisement information according to the present location of the mobile advertising device. Wherein, the advertisement-processing module selects the advertisement of the store by comparing the present location of the mobile advertising device with the location information corresponding to the advertisement information. Then the advertisement-processing module transmits the advertisement of the store to the mobile advertising device through the wireless communication unit. Therefore, the advertisement of the store is displayed on the e-paper of the mobile advertising device.

According to still another embodiment of this invention, a mobile advertising method is provided. Wherein at least a mobile advertising device and a server execute the mobile advertising method for mobile advertisements. The steps executed in the mobile advertising device include: a present location of the mobile advertising device is calculated according to a positioning signal. At least one advertisement of at least one store corresponding to the present location of the mobile advertising device is obtained from the server. The advertisement of the store is displayed on the e-paper of the mobile advertising device.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of a mobile advertising system according to an embodiment of this invention;

FIG. 2 is a flow diagram of a mobile advertising method according to another embodiment of this invention; and

FIG. 3 is a flow diagram of a mobile advertising method according to still another embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

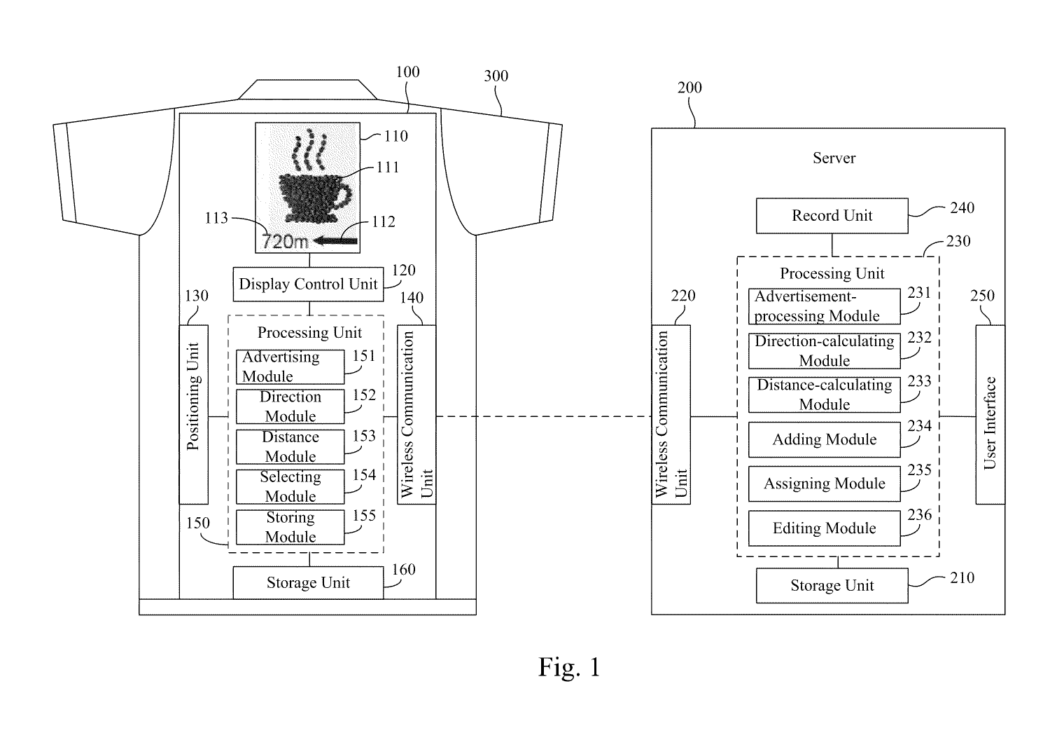

FIG. 1 is a block diagram of a mobile advertising system according to an embodiment of this invention. The mobile advertising system includes at least a mobile advertising device 100 and a server 200. The mobile advertising device 100 obtains an advertisement corresponding to its location from the server 200, and displays the received advertisement on an e-paper of the mobile advertising device 100.

The mobile advertising device 100 includes an e-paper 110, a display control unit 120, a positioning unit 130, a wireless communication unit 140 and a processing unit 150. The display control unit 120 controls the e-paper 110. The positioning unit 130 receives a positioning signal and calculates the present location of the mobile advertising device 100 according to the positioning signal. The wireless communication unit 140 builds a connection with the server 200 through wireless communication and transmits the present location of the mobile advertising device 100 to the server 200. The processing unit 150 includes an advertising module 151 to obtain at least one advertisement of at least one store corresponding to the present location of the mobile advertising device 100 from the server 200 through the wireless communication unit 140. Wherein the at least one advertisement of the at least one store may be obtained when the at least one store is in the vicinity of the mobile advertising device 100. In addition, when the present location of the mobile advertising device 100 is suitable for advertising the at least one store, the at least one advertisement of the at least one store may also be obtained.

When the number of the at least one advertisements of the at least one stores obtained from the server 200 is more than one, a selecting module 154 of the processing unit 150 may select one of the at least one advertisements of the at least one stores obtained from the server 200. In other words, when the server 200 transmits several advertisements of several stores, the mobile advertising device 100 may select one to display. Then, the advertising module 151 displays the obtained (or selected) advertisement 111 of the store on the e-paper 110 through the display control unit 120. Therefore, the advertisement of the store corresponding to the present location of the mobile advertising device 100 can be obtained and displayed on the e-paper 110 of the mobile advertising device 100.

The positioning unit 130 may utilize Global Positioning System (GPS), Assisted Global Positioning System (AGPS), Cell-ID Positioning, Angle of Arrival (AoA), Time of Arrival (ToA), Time Difference of Arrival (TDoA), Radio Frequency Identification (RFID) or any other positioning method to calculate the present location of the mobile advertising device 100. The wireless communication method utilized by the wireless communication unit 140 may be 3G, 3.5G, 4G, Worldwide Interoperability for Microwave Access (WiMax), Long Term Evolution (LTE), WiFi, IEEE 802.11 series, bluetooth, Zigbee or any other wireless communication method.

Since the e-paper 110 is lightweight and flexible, the mobile advertising device 100 can be embedded in the clothes 300. In other embodiments, the mobile advertising device 100 can be embedded in other objects, such as a backpack, a hat or any other wearable object, and the e-paper 110 of the mobile advertising device 100 can be installed on the surface of the objects.

The processing unit 150 may further includes a direction module 152, a distance module 153 or a storing module 155. The direction module 152 obtains a direction to the store through the wireless communication unit 140 from the server 200. Then, the direction module 152 displays the direction 112 on the e-paper 110 through the display control unit 120, which shows users the direction to the store. Therefore, the users can go to the store according to the direction 112 displayed on the e-paper 110.

The distance module 153 obtains a present distance to the store through the wireless communication unit 140 from the server 200. Then, the distance module 153 displays the present distance 113 on the e-paper 110 through the display control unit 120, which shows users the present distance between the mobile advertising device 100 and the store.

When the advertising module 151 obtains the advertisement of the store from the server 200, the storing module 155 stores the advertisement of the store into a storage unit 160 of the mobile advertising device 100 to be a pre-stored advertisement. Therefore, when the advertising module 151 can't obtain the advertisement of the store, the processing unit 150 obtains the pre-stored advertisement from the storage unit 160. Then, the processing unit 150 displays the pre-stored advertisement on the e-paper 110 through the display control unit 120. Wherein the reason that the advertising module 151 can't obtain the advertisement of the store may be bad connection to the server 200. In addition, when no positioning signal is received, the mobile advertising device 100 can't be positioned, which may cause the advertisement corresponding to the present location of the mobile advertising device 100 not be obtained either.

Above all, the advertisement of the store, the direction and the present distance to the store are all obtained from the server 200. Therefore, less complicated processor can be utilized as the processing unit 150 for reducing size and power consumption of the mobile advertising device 100, which can raise portability of the mobile advertising device 100.

On the other hand, the server 200 includes a storage unit 210, a wireless communication unit 220 and a processing unit 230. The storage unit 210 stores advertisement information. Wherein, location information corresponding to the advertisement information, such as coordinates, addresses or any other location related information of stores in the advertisement information, is attached in the advertisement information. The wireless communication unit 220 builds a connection with the mobile advertising device 100 through wireless communication, and receives the present location of the mobile advertising device 100. The wireless communication method utilized by the wireless communication unit 220 of the server 200 may be 3G, 3.5G, 4G, WiMax, LTE, WiFi, IEEE 802.11 series, bluetooth, Zigbee or any other wireless communication method.

The processing unit 230 includes an advertisement-processing module 231 to select the advertisement of the store from the advertisement information according to the present location of the mobile advertising device 100. In detail, the advertisement-processing module 231 selects the advertisement of the store by comparing the present location of the mobile advertising device 100 with the location information corresponding to the advertisement information in the storage unit 210. Wherein the advertisement of the store may be selected when the store is in the vicinity of the mobile advertising device 100. In addition, when the present location of the mobile advertising device 100 is suitable for advertising the at least one store, the at least one advertisement of the at least one store may also be selected. Then, the advertisement-processing module 231 transmits the advertisement of the store to the mobile advertising device 100 through the wireless communication unit 220. Therefore, the advertisement of the store can be displayed on the e-paper 110 of the mobile advertising device 100. In addition, there may be more mobile advertising devices in the mobile advertising system in other embodiments.

Since the mobile advertising device 100 is portable, the mobile advertising device 100 can be used as a mobile advertisement board. In other words, several people can be hired to wear the mobile advertising device 100, and walk on the street to show others the advertisement corresponding to the present location of the mobile advertising device 100. Therefore, the server 200 may include a record unit 240 to record or analyze work information of the mobile advertising device 100. Wherein the work information of the mobile advertising device 100 may include identification information of the mobile advertising device 100, motion track of the mobile advertising device 100, advertisement number and list displayed on the mobile advertising device 100, accumulative display time of each displayed advertisement, display area of each displayed advertisement, or any other work information of the mobile advertising device 100. Accordingly, the recorded work information of the mobile advertising device 100 may be utilized to calculate the charge for displaying the advertisement. Also, the recorded work information of the mobile advertising device 100 may be utilized to calculate the pay for the people wearing the mobile advertising device 100. In addition, according to the analysis of the work information of the mobile advertising device 100, the strategy of selecting the advertisement of the store utilized by the advertisement-processing module 231 can be amended.

Moreover, the processing unit may include a direction-calculating module 232 or a distance-calculating module 233. The direction-calculating module 232 calculates a direction for the mobile advertising device 100 to the store according to the present location of the mobile advertising device 100 and the location information of the advertisement. Then, the direction-calculating module 232 transmits the direction to the mobile advertising device 100 through the wireless communication unit 220. Therefore, the direction to the store can be displayed on the e-paper 110 of the mobile advertising device 100.

The distance-calculating module 233 calculates a present distance between the mobile advertising device 100 and the store. Then, the distance-calculating module 233 transmits the present distance to the mobile advertising device 100 through the wireless communication unit 200. Therefore, the present distance between the mobile advertising device 100 and the store can be displayed on the e-paper 110 of the mobile advertising device 100.

Furthermore, the server 200 may utilize an adding module 234 of the processing unit 230 to obtain new advertisement information and add the new advertisement to the storage unit 210. Wherein the new advertisement information can be obtained through an optical disk drive, network or any other data transmission interface. Therefore, the server 200 can utilize the adding module 234 to add new advertisements to the storage unit 210 of the server 200.

The server 200 may utilize an assigning module 235 of the processing unit 230 to obtain an assigning signal from a user interface 250 of the server 200. Then, the assigning module 235 assigns a specified advertisement to the mobile advertising device 100 according to the assigning signal. Therefore, the specified advertisement is displayed on the e-paper 110 of the mobile advertising device 100. In other words, users can assign the specified advertisement he/she wants to be displayed on the e-paper of the assigned mobile advertising device.

The server 200 may utilize an editing module 236 to obtain an advertisement-editing signal from the user interface 250 of the server 200. Then, the editing module 236 edits the advertisement information in the storage unit 210 according to the advertisement-editing signal. Wherein the edit action to the advertisement information may include delete, amend or any other edit-related action. Therefore, users can edit advertisement information stored in the storage unit 210 through the user interface 250 of the server 200.

In addition, the server 200 may utilize the adding module 234 to detect a digital device with an e-paper and add the detected digital device as the mobile advertising device 100. Also, the server 200 may utilize the editing module 236 to obtain a device-editing signal from the user interface 250. Then, the editing module 236 edits work information of the mobile advertising device 100 according to the device-editing signal. Wherein the edit action to the work information of the mobile advertising device 100 may include delete, amend or any other edit-related action. Therefore, users can add new digital devices as the mobile advertising device 100, or edits work information of the mobile advertising device 100 through the server 200.

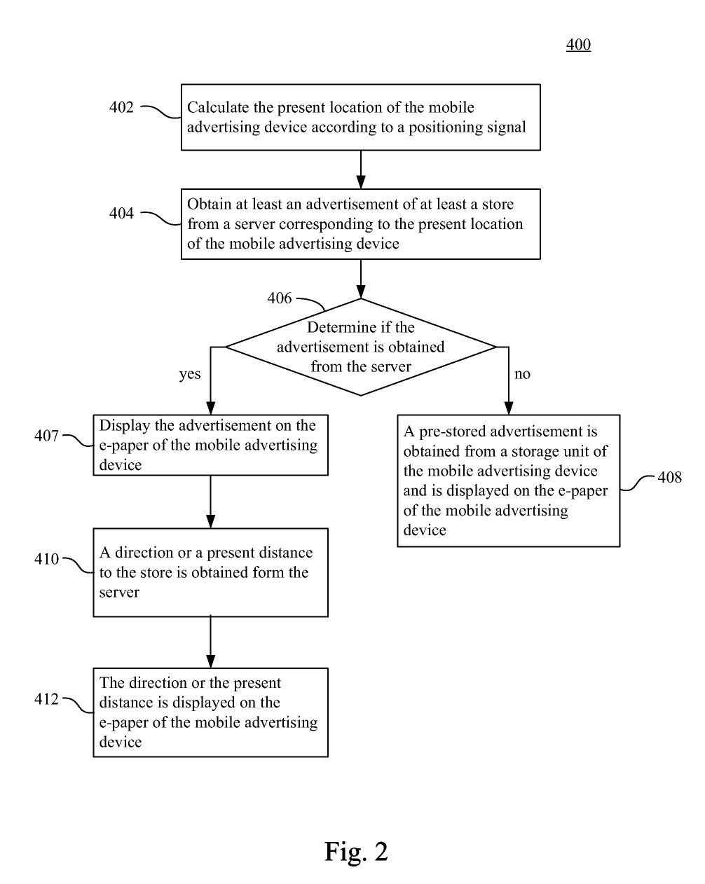

FIG. 2 is a flow diagram of a mobile advertising method executed in a mobile advertising device according to another embodiment of this invention. In the mobile advertising method 400 executed in the mobile advertising device, an advertisement is obtained according to a present location of the mobile advertising device from a server. Then, the obtained advertisement is displayed on an e-paper of the mobile advertising device. The mobile advertising method 400 executed in the mobile advertising device includes following steps:

Calculate the present location of the mobile advertising device according to a positioning signal (step 402). Wherein, the positioning signal of GPS, AGPS, Cell-ID Positioning, AoA, ToA, TDoA, RFID or any other positioning method may be utilized to calculate the present location in the step 402.

In step 404, obtain at least one advertisement of at least one store corresponding to the present location of the mobile advertising device from the server. Wherein the present location of the mobile advertising device may be transmitted to the server, such that the server selects the at least one advertisement of the at least one store corresponding to the present location of the mobile advertising device and replies the selected advertisement to the mobile advertising device. The at least one advertisement of the at least one store may be selected by the server when the at least one store is in the vicinity of the mobile advertising device. In addition, when the present location of the mobile advertising device is suitable for advertising the at least one store, the at least one advertisement of the at least one store may also be selected. When the number of the at least one advertisements of the at least one stores is more than one, one of which may be selected for displayed on the e-paper of the mobile advertising device.

In step 407, display the obtained (or selected) advertisement of the store on the e-paper of the mobile advertising device. Since the e-paper is lightweight and flexible, the e-paper can be embedded in clothes, backpacks, hats or any other wearable objects. Therefore, the objects applied for the mobile advertising method 400 are wearable.

Before the step 407, the mobile advertising method 400 may include step 406 to determine if the advertisement is obtained from the server. When the advertisement is not obtained from the server, a pre-stored advertisement is obtained from a storage unit of the mobile advertising device and is displayed on the e-paper of the mobile advertising device (step 408). Wherein the reason that the advertisement can't be obtained may be bad connection to the server. In addition, when no positioning signal is received, the mobile advertising device can't be positioned, which may cause that the advertisement corresponding to the present location of the mobile advertising device 100 can't be obtained either.

Only when the advertisement is obtained from the server, the advertisement of the store is displayed on the e-paper of the mobile advertising device (step 407). Furthermore, when the advertisement is obtained from the server, the advertisement obtained from the server can be stored into the storage unit of the mobile advertising device to be the pre-stored advertisement.

In addition, a direction or a present distance to the store may be obtained from the server according to the present location of the mobile advertising device (step 410). Then, in step 412, the direction or the present distance is displayed on the e-paper of the mobile advertising device. Therefore, users can go to the store according to the direction or the present distance displayed on the e-paper.

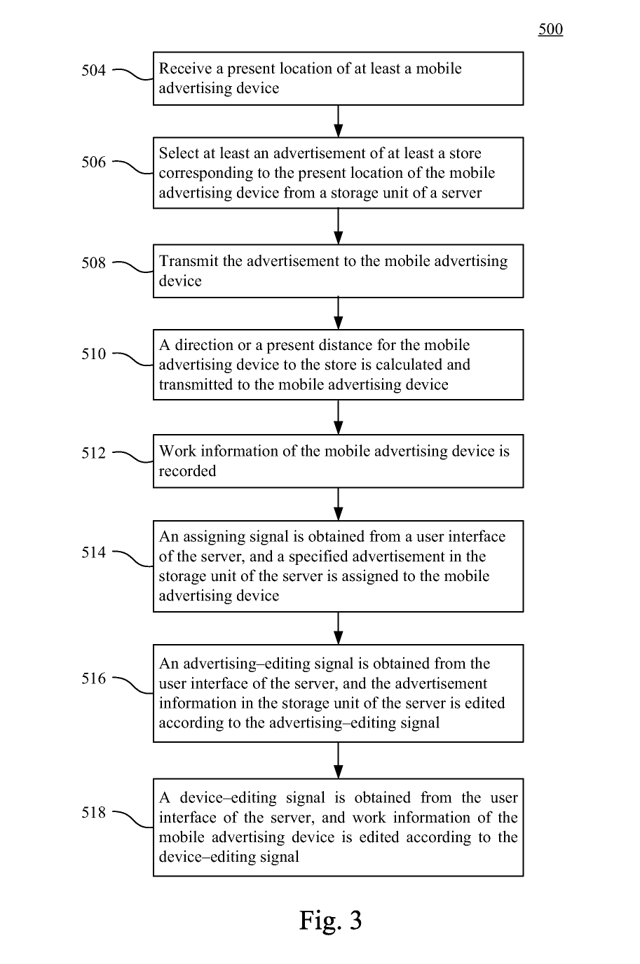

FIG. 3 is a flow diagram of a mobile advertising method executed in a server according to still another embodiment of this invention. In the mobile advertising method 500 executed in the server, an advertisement corresponding to a present location of at least one mobile advertising device is transmitted to the mobile advertising device. Then, the mobile advertising device displays the received advertisement on its e-paper. The mobile advertising method 500 executed in the server includes following steps:

In step 504, receive a present location of at least one mobile advertising device. Wherein the present location of the mobile advertising device can be received through wireless communication, such as 3G, 3.5G, 4G, WiMax, LTE, WiFi, IEEE 802.11 series, bluetooth, Zigbee or any other wireless communication method. In addition, before step 504, a digital device with an e-paper may be detected, and the detected digital device may be added as the mobile advertising device.

In step 506, select at least one advertisement of at least one store corresponding to the present location of the mobile advertising device from a storage unit of the server. Wherein the at least one advertisement of the at least one store may be selected when the at least one store is in the vicinity of the mobile advertising device. In addition, when the present location of the mobile advertising device is suitable for advertising the at least one store, the at least one advertisement of the at least one store may also be selected. Before step 506, new advertisement information may be obtained from a data transmission interface, such as an optical disk drive, network or any other data transmission interface, and added to the storage unit of the server for selecting.

In step 508, transmit the advertisement of the store to the mobile advertising device. Then, the mobile advertising device displays the advertisement of the store on the e-paper of the mobile advertising device.

In addition, a direction or a present distance for the mobile advertising device to the store may be calculated and transmitted to the mobile advertising device (step 510). Then, the mobile advertising device can display the direction to the store or the present distance between the mobile advertising device and the store. Therefore, less complicated processor can be utilized in the mobile advertising device to reduce size and power consumption of the mobile advertising device, which can raise portability of the mobile advertising device.

Furthermore, work information of the mobile advertising device may be recorded (step 512). Wherein the work information of the mobile advertising device may include identification information of the mobile advertising device, motion track of the mobile advertising device, advertisement number and list displayed on the mobile advertising device, accumulative display time of each displayed advertisement, display area of each displayed advertisement, or any other work information of the mobile advertising device. Accordingly, the recorded work information of the mobile advertising device may be utilized to calculate the charge for displaying the advertisement. Also, the recorded work information of the mobile advertising device may be utilized to calculate the pay for hiring people to wear the mobile advertising device for mobile advertising.

In step 514, an assigning signal may be obtained from a user interface of the server and a specified advertisement in the storage unit of the server is assigned to the mobile advertising device. Therefore, users can assign the specified advertisement he/she wants to be displayed on the e-paper of the assigned mobile advertising device.

In step 516, an advertisement-editing signal may be obtained from the user interface of the server, and the advertisement information in the storage unit is edited according to the advertisement-editing signal. Wherein the edit action to the advertisement information may include delete, amend or any other edit-related action. Therefore, users can edit advertisement information stored in the storage unit.

In step 518, a device-editing signal is obtained from the user interface of the server, and work information of the mobile advertising device is edited according to the device-editing signal. Wherein the edit action to the work information of the mobile advertising device may include delete, amend or any other edit-related action. Therefore, users can add new digital devices as the mobile advertising device, or edits work information of the mobile advertising device through the server.

Although the present invention has been described in considerable detail with reference to certain embodiments thereof, other embodiments are possible. Therefore, their spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A mobile advertising device, comprising:
an e-paper;
a display control unit to control the e-paper;
a positioning unit to receive a positioning signal and calculate a present location of the mobile advertising device according to the positioning signal;
a wireless communication unit to build a connection with a server through wireless communication and transmit the present location of the mobile advertising device to the server; and
a processing unit, comprising:
an advertising module to obtain at least one advertisement of at least one store corresponding to the present location of the mobile advertising device from the server through the wireless communication unit, and display the advertisement of the store on the e-paper through the display control unit.

2. The mobile advertising device of claim 1, wherein the processing unit further comprises:
a direction module to obtain a direction to the store through the wireless communication unit from the server, and display the direction on the e-paper through the display control unit.

3. The mobile advertising device of claim 1, wherein the processing unit further comprises:
a distance module to obtain a present distance to the store through the wireless communication unit from the server, and display the present distance on the e-paper through the display control unit.

4. The mobile advertising device of claim 1, wherein the processing unit further comprises:
a selecting module to select one of the at least one advertisement of the at least one store to be displayed on the e-paper through the display control unit when the number of the at least one advertisement of the at least one store obtained from the server is more than one.

5. The mobile advertising device of claim 1, further comprising:
a storage unit to store a pre-stored advertisement;
wherein the processing unit displays the pre-stored advertisement on the e-paper through the display control unit when the advertisement of the store is not obtained from the server.

6. The mobile advertising device of claim 5, wherein the processing unit further comprises:
a storing module to store the advertisement of the store into the storage unit to be the pre-stored advertisement when the advertisement of the store is obtained from the server.

7. A mobile advertising system, wherein a server of the mobile advertising system selects at least one advertisement of at least one store corresponding to a present location of a mobile advertising device of the mobile advertising system and makes the advertisement of the store displayed on an e-paper of the mobile advertising device, the server comprises:
a storage unit to store advertisement information, wherein location information corresponding to the advertisement information is attached in the advertisement information;
a wireless communication unit to build a connection with the mobile advertising device through wireless communication, and receive the present location of the mobile advertising device; and
a processing unit, comprising:
an advertisement-processing module to select the advertisement of the store from the advertisement information according to the present location of the mobile advertising device, and transmit the advertisement of the store to the mobile advertising device through the wireless communication unit, such that the advertisement of the store is displayed on the e-paper of the mobile advertising device, wherein the advertisement of the store is selected by comparing the present location of the mobile advertising device with the location information corresponding to the advertisement information.

8. The mobile advertising system of claim 7, wherein the processing unit of the server further comprises:
a direction-calculating module to calculate a direction for the mobile advertising device to the store according to the present location of the mobile advertising device and the location information of the advertisement, and transmit the direction to the mobile advertising device through the wireless communication unit, such that the direction is displayed on the e-paper of the mobile advertising device.

9. The mobile advertising system of claim 7, wherein the processing unit of the server further comprises:
a distance-calculating module to calculate a present distance between the mobile advertising device and the store, and transmit the present distance to the mobile advertising device through the wireless communication unit, such that the present distance is displayed on the e-paper of the mobile advertising device.

10. The mobile advertising system of claim 7, wherein the server further comprises:
a record unit to record or analyze work information of the mobile advertising device.

11. The mobile advertising system of claim 7, wherein the processing unit of the server further comprises:
an adding module to obtain new advertisement information and add the new advertisement information into the storage unit;
an assigning module to obtain an assigning signal from a user interface of the server and assign a specified advertisement to the mobile advertising device according to the assigning signal, such that the specified advertisement is displayed on the e-paper of the mobile advertising device; and
an editing module to obtain an advertisement-editing signal from the user interface of the server and editing the advertisement information in the storage unit according to the advertisement-editing signal.

12. The mobile advertising system of claim 7, wherein the processing unit of the server further comprises:
an adding module to detect a digital device with an e-paper and add the detected digital device as the mobile advertising device; and
an editing module to obtain a device-editing signal from a user interface of the server and edit work information of the mobile advertising device according to the device-editing signal.

13. A mobile advertising method, wherein at least a mobile advertising device and a server execute the mobile advertising method for mobile advertisement, and steps executed in the mobile advertising device comprise:
calculating a present location of the mobile advertising device according to a positioning signal;
obtaining at least one advertisement of at least one store corresponding to the present location of the mobile advertising device from the server; and
displaying the advertisement of the store on the e-paper of the mobile advertising device.

14. The mobile advertising method of claim 13, wherein steps executed in the mobile advertising device further comprises:
obtaining a direction to the store according to the present location of the mobile advertising device from the server; and
displaying the direction on the e-paper of the mobile advertising device.

15. The mobile advertising method of claim 13, wherein steps executed in the mobile advertising device further comprises:
obtaining a present distance to the store according to the present location of the mobile advertising device from the server; and
displaying the present distance on the e-paper of the mobile advertising device.

16. The mobile advertising method of claim 13, wherein steps executed in the mobile advertising device further comprises:
when the number of the at least one advertisement of the at least one store obtained from the server is more than one, selecting one of the at least one advertisement of the at least one store to be displayed on the e-paper of the mobile advertising device.

17. The mobile advertising method of claim 13, wherein the steps executed in the mobile advertising device further comprises:
determining if the advertisement is obtained from the server;
when the advertisement is not obtained from the server, a pre-stored advertisement is obtained from a storage unit of the mobile advertising device and is displayed on the e-paper of the mobile advertising device; and
when the advertisement is obtained from the server, the advertisement obtained from the server is stored into the storage unit of the mobile advertising device to be the pre-stored advertisement.

18. The mobile advertising method of claim 13, wherein the steps executed by the server comprises:
receiving the present location of the mobile advertising device;
selecting the advertisement of the store from a storage unit of the server corresponding to the present location of the mobile advertising device;
transmitting the advertisement of the store to the mobile advertising device, such that the advertisement of the store is displayed on the e-paper of the mobile advertising device; and
recording work information of the mobile advertising device.

19. The mobile advertising method of claim 18, wherein the steps executed by the server further comprises:
calculating a direction for the mobile advertising device to the store according to the present location of the mobile advertising device and location information of the advertisement; and
transmitting the direction to the mobile advertising device, such that the direction is displayed on the e-paper of the mobile advertising device.

20. The mobile advertising method of claim 18, wherein the steps executed by the server further comprises:
calculating a present distance between the mobile advertising device and the store; and
transmitting the present distance to the mobile advertising device, such that the present distance is displayed on the e-paper of the mobile advertising device.

21. The mobile advertising method of claim 18, wherein the steps executed by the server further comprises:
obtaining new advertisement information and adding the new advertisement information to the storage unit of the server;
obtaining an assigning signal from a user interface of the server and assigning a specified advertisement to the mobile advertising device according to the assigning signal, such that the specified advertisement is displayed on the e-paper of the mobile advertising device; and
obtaining an advertisement-editing signal from the user interface of the server and editing the advertisement information in the storage unit of the server according to the advertisement-editing signal.

22. The mobile advertising method of claim 18, wherein the steps executed by the server further comprises:
detecting a digital device with an e-paper and adding the detected digital device as the mobile advertising device; and
obtaining a device-editing signal from a user interface of the server and editing work information of the mobile advertising device according to the device-editing signal.
